(19) United States
(12) Patent Application Publication
(10) Pub. No.: US 2018/0250854 A1
(43) Pub. Date: Sep. 6, 2018

(54) MOLDED POLYMERIC STRUCTURES HAVING A METALLIZED SURFACE

(71) Applicant: Ford Global Technologies, LLC, Dearborn, MI (US)

(72) Inventors: Paul Kenneth Dellock, Northville, MI (US); Thomas Musleh, Canton, MI (US); LaRon Michelle Brown, Commerce Township, MI (US); Michael A. Musleh, Canton, MI (US); Stuart C. Salter, White Lake, MI (US)

(73) Assignee: Ford Global Technologies, LLC, Dearborn, MI (US)

(21) Appl. No.: 15/448,653

(22) Filed: Mar. 3, 2017

(51) Int. Cl. B29C 45/00; C23C 18/31; C23F 1/16

(52) U.S. Cl. CPC B29C 45/0001; B29L 2031/30; C23F 1/16; C23C 18/31

(57) ABSTRACT

A molded metallized polymeric structure includes a metal plate-able polymer component having a metallized surface wherein the component includes one or more locking members. The molded metallized polymeric structure additionally includes a polymer resin coupled to one or more binding regions of the metallized surface wherein the polymer resin is positioned to be in contact with the one or more locking members. The molded metallized polymeric structure has one or more visually exposed portions of the metallized surface.

### FIELD OF THE DISCLOSURE

The present disclosure generally relates to components having a chromed portion, and more specifically, a vehicle grille or component having complex geometries having at least a partially metallized surface.

### BACKGROUND OF THE DISCLOSURE

Polymeric materials are used in a wide variety of applications in vehicles. For example, these plastic materials may be used to provide reduced weight, cost, and increased corrosion resistance, among other benefits. In some applications, plastic materials may be used as decorative components, for example, in detailing on radiator grilles, logos, and trim. These types of decorative components may additionally be used in a wide variety of other applications such as consumer goods, appliances, or architectural components. In many of these applications, the plastic materials may be desired to have multiple surface finishes, for example, a portion of the surface finish may be a chromed or metallized surface while another portion of the surface finish could be a non-metallized or colored portion. Depending on the type of finish and material used, these components need to be durable, aesthetically pleasing, and cost effective.

Currently used methods in the art are limited in their ability to make components having multiple surface finishes in a cost effective and efficient manner. For example, the use of hot stamping metal film or foil into the desired shape or precisely placing metal foil into an injection mold are time consuming and produce products with limited durability and precision. These existing approaches require the need for new methods to make components having complex geometries having at least a partially metallized surface in an efficient and cost effective manner.

### SUMMARY OF THE DISCLOSURE

According to one aspect of the present disclosure, a molded metallized polymeric structure is provided. The molded metallized polymeric structure includes a metal plate-able polymer component having a fully metallized surface with one or more locking members, a polymer resin coupled to one or more regions of the fully metallized surface wherein the polymer resin is positioned to be in contact with the one or more locking members, and one or more visually exposed portions of the fully metallized surface.

According to another aspect of the present disclosure, a method of forming a molded metallized polymeric structure is provided. The method includes injection molding a metal plate-able polymer component having one or more locking members, metal plating the metal plate-able polymer component to form a fully metallized surface, and injection molding a polymer resin to chemically bond to one or more regions of the fully metallized surface kept in position by the one or more locking members.

According to another aspect of the present disclosure, a chromed lattice component for an automobile is provided. The chromed lattice component includes an acrylonitrile butadiene styrene copolymer component having a fully chromed surface wherein the component includes one or more locking members, a polymer resin coupled to one or more regions of the fully chromed surface wherein the polymer resin is positioned to be in contact with the one or more locking members, and one or more visually exposed portions of the fully metallized surface.

These and other aspects, objects, and features of the present disclosure will be understood and appreciated by those skilled in the art upon studying the following specification, claims, and appended drawings.

### BRIEF DESCRIPTION OF THE DRAWINGS

In the drawings:

FIG. 1 is a front perspective view of a vehicle according to some embodiments of the present disclosure;

FIG. 2A is a partially fragmentary isometric view of a grille portion of the vehicle according to some embodiments taken and enlarged from the portion labeled II in the vehicle of FIG. 1;

FIG. 2B is a partially fragmentary isometric view of a grille portion of the vehicle according to some embodiments taken and enlarged from the portion labeled II in the vehicle of FIG. 1;

FIG. 2C is a partially fragmentary isometric view of a grille portion of the vehicle according to some embodiments taken and enlarged from the portion labeled II in the vehicle of FIG. 1;

FIG. 2D is a partially fragmentary isometric view of a grille portion of the vehicle according to some embodiments taken and enlarged from the portion labeled II in the vehicle of FIG. 1;

FIG. 3A is a cross-sectional view of the grille of FIG. 2A taken along the line IIIA-IIIA;

FIG. 3B is a cross-sectional view of the grille of FIG. 2B taken along the line

FIG. 4A is a partially schematic cross-sectional view of a two-shot rotational injection molding machine according to some embodiments of the current disclosure;

FIG. 4B is the partially schematic cross-sectional view of the two-shot rotational injection molding machine shown in FIG. 4A after injection;

FIG. 5A is an isometric view of a metal plate-able polymer component according to some embodiments of the current disclosure;

FIG. 5B is an isometric view of the metal plate-able polymer component of FIG. 5A having a metallized surface according to some embodiments of the present disclosure;

FIG. 5C is an isometric view of the metal plate-able polymer component having the metallized surface of FIG. 5B having a polymer resin coupled according to some embodiments of the present disclosure;

FIG. 6 is a flow diagram of a method for forming a molded metallized polymeric structure according to some embodiments of the present disclosure; and

FIG. 7 is a flow diagram of a method for chroming a metal plate-able polymer component according to some embodiments of the present disclosure.

### DETAILED DESCRIPTION OF THE PREFERRED EMBODIMENTS

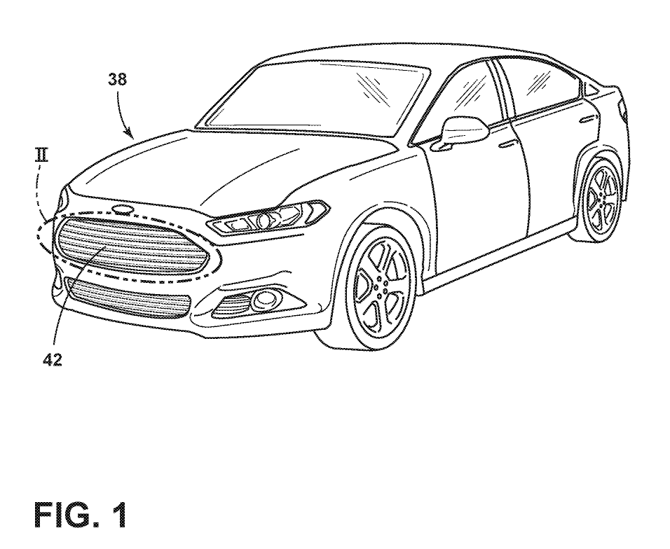

For purposes of description herein, the terms “upper,” “lower,” “right,” “left,” “rear,” “front,” “vertical,” “horizontal,” “interior,” “exterior,” and derivatives thereof shall relate to the device as oriented in FIG. 1. However, it is to be understood that the device may assume various alternative orientations, except where expressly specified to the contrary. It is also to be understood that the specific devices and processes illustrated in the attached drawing, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise. Additionally, unless otherwise specified, it is to be understood that discussion of a particular feature of component extending in or along a given direction or the like does not mean that the feature or component follows a straight line or axis in such a direction or that it only extends in such direction or on such a plane without other directional components or deviations, unless otherwise specified.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

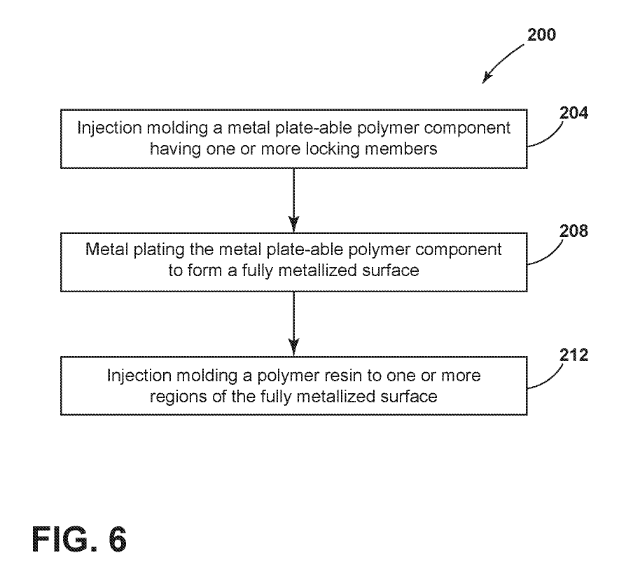

Referring to FIGS. 1-7, reference numeral 10 generally designates a molded metallized polymeric structure. The molded metallized polymeric structure 10 includes a metal plate-able polymer component 14 having a metallized surface 18 wherein the component 14 includes one or more locking members 22. The molded metallized polymeric structure 10 additionally includes a polymer resin 26 coupled to one or more binding regions 30 of the metallized surface 18 wherein the polymer resin 26 is positioned to be in contact with the one or more locking members 22. The molded metallized polymeric structure 10 has one or more visually exposed portions 34 of the metallized surface 18.

The metal plate-able polymer component 14 may be made from a variety of thermoplastic or thermoset polymers and/or copolymers. In some embodiments, for example, the metal plate-able polymer component 14 may be made from acrylonitrile butadiene styrene (ABS) copolymer, a polycarbonate acrylonitrile butadiene styrene (PC-ABS) copolymer, polypropylene, polysulfone, polyethersulfone, polyetherimide, polyaramids, Teflon, polyarylether, polycarbonate, polyphenylene oxide, polyacetal, urea formaldehyde, diallyl phthalate, mineral-reinforced nylon, and phenolic polymers. In other embodiments, the metal plate-able polymer component 14 may be made or formed from an acrylonitrile butadiene styrene copolymer, a polycarbonate acrylonitrile butadiene styrene copolymer, and combinations thereof.

The polymer resin 26 of the molded metallized polymeric structure 10 may include one or more thermoplastic or thermoset polymers and/or copolymers. The polymer resin 26 used should be selected from materials that can chemical bond and/or adhere to chrome or respective metallized surface 18. In some embodiments, the polymer resin 26 chemically bonds to the metallized surface 18 and in other embodiments the polymer resin 26 physically adheres to the metallized surface 18. In some embodiments, the polymer resin 26 includes an acrylonitrile styrene acrylate (ASA) copolymer. The polymer resin 26 may additionally incorporate metal flakes, colorants, refractive particles, diffractive particles, other additives, or a combination thereof to give a desired look and/or material properties for the final molded metallized polymeric structure 10. In addition, the polymer resin 26 may have a variable gloss finish, a high gloss finish, a low gloss finish, a grained finish, a textured finish, a matte finish, a brushed finish, or a polished finish.

The use of the metal plate-able polymer component 14 and/or the polymer resin 26 can offer benefits including low cost, low coefficient of thermal expansion, ease of molding, good metal adhesion, and good appearance after metal plating.

The metallized surface 18 of the molded metallized polymeric structure 10 may include a variety of different metals or metal alloys to produce the desired look of the metallized surface 18. In some embodiments, the metallized surface 18 may be a chrome, satin chrome, brass, gold, silver, copper, titanium, aluminum, nickel, and/or other metal alloy plating. In some embodiments, the metallized surface 18 is a chrome plating. Depending on the application and/or desired appearance, the metallized surface 18 can cover the entire surface of the molded metallized polymeric structure 10 or just a portion of the molded metallized polymeric structure 10. Coating or covers known in the art can be used to prevent portions of the molded metallized polymeric structure 10 from being electroplated or chromed.

Referring to FIG. 1, a vehicle 38 is shown having the molded metallized polymeric structure 10 including a grille 42. The vehicle 38, is shown as a car although the type of vehicle 38 is not meant to be limiting and the vehicle 38 could additionally be, for example, a minivan, truck, commercial vehicle, or any other wheeled motorized vehicle. The molded metallized polymeric structure 10 is not meant to be limited to the grille 42 and can include any decorative component on the vehicle 38, an appliance, or alternative apparatus. For example, in some embodiments, the molded metallized polymeric structure 10 can include side paneling, logos, emblems, badges, paneling, fairings, and/or other trim pieces.

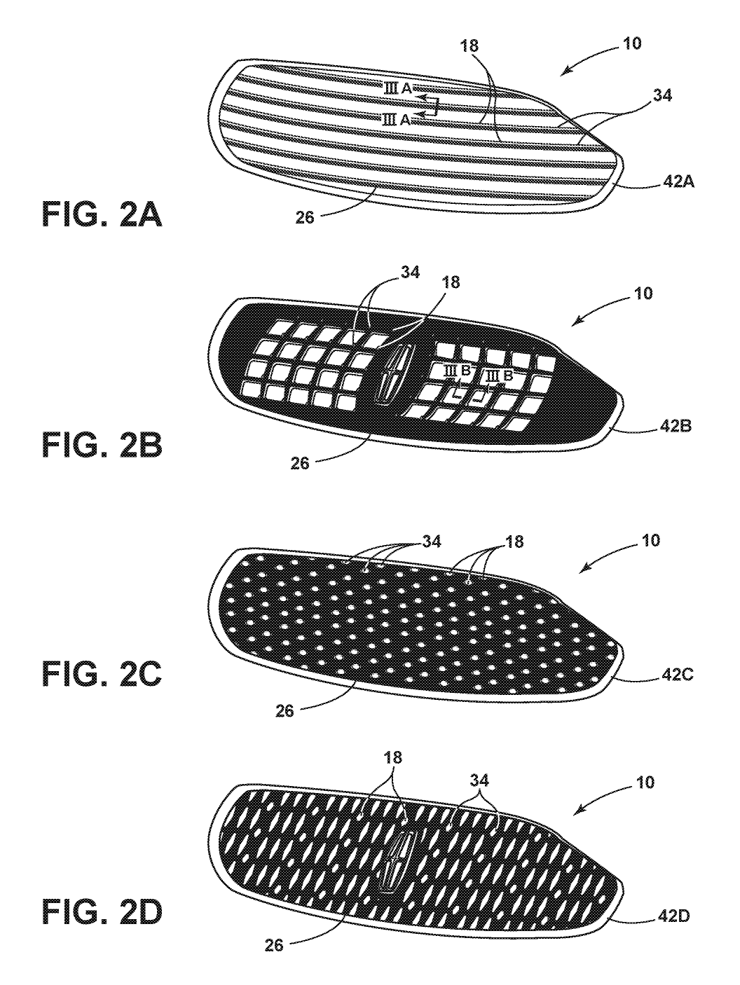

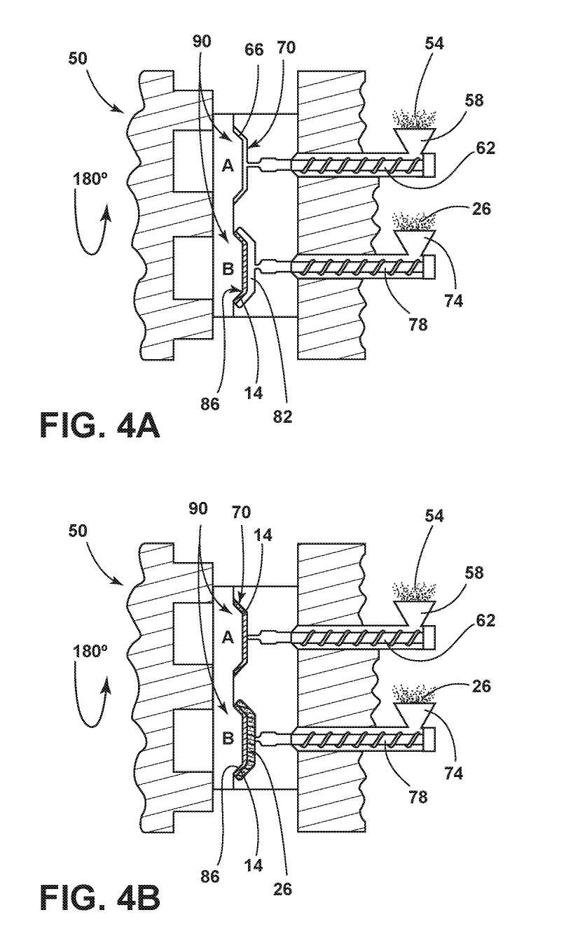

Referring now to FIGS. 2A-2D, a variety of different grilles 42 are shown for the vehicle 38. FIG. 2A is a linear grille 42A taken and enlarged from the portion of the grille 42 shown in the vehicle of FIG. 1. FIG. 2B is a checkered grille 42B including a badge positioned in the center of the checkered grille 42B. FIG. 2C is an arrayed uniform grille 42C where the arrayed uniform grille 42C has a plurality of ventilation holes evenly spaced throughout the grille 42C. FIG. 4D is an arrayed non-uniform grille 42D where the non-uniform grille 42 has a plurality of holes in a non-uniform pattern. The holes or openings positioned in the grille 42 may be provided in a variety of shapes and patterns and are not meant to be limiting. In some embodiments, the holes may be circular, square, oval, diamond, oblique, or ellipsoidal, and may be positioned having uniform or non-uniform spacing. Each of the grilles 42A-42D are shown as molded metallized polymeric structures 10 including visually exposed regions 34 of the metallized surface 18 positioned within gaps in the polymer resin 26.

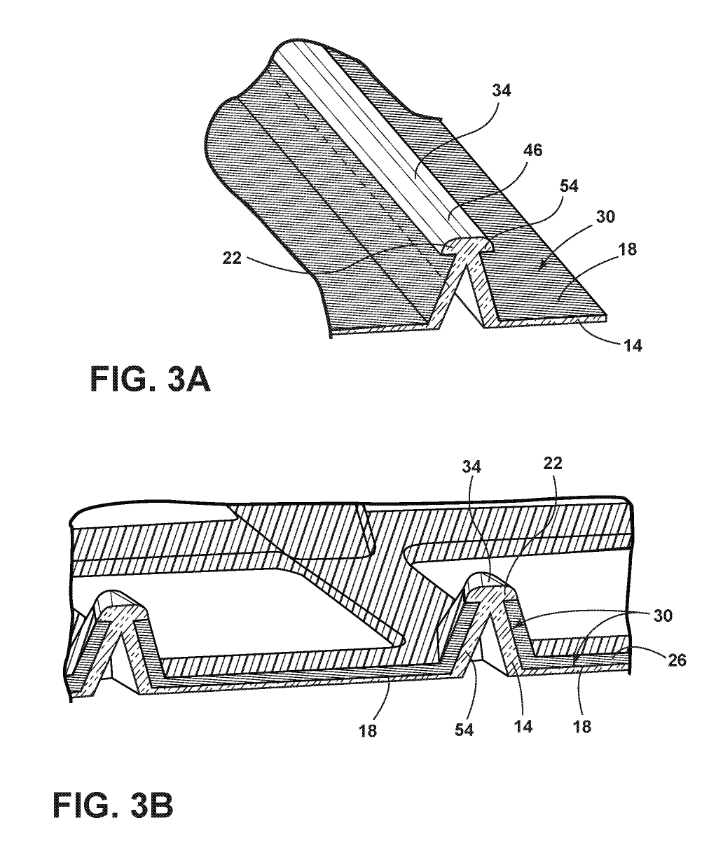

Referring to FIG. 3A, a cross-sectional view of the linear grille 42A represented in FIG.

2A is shown taken along the line IIIA-IIIA. Each of the grilles 42A-42D may have one or more locking members 22 positioned along each of the edge members of the grille 42. FIG. 3A additionally shows the metal plate-able polymer component 14 having the metallized surface 18 coupled where the metal plate-able polymer component 14 forms a surface making up the binding region 30. The entire metallized surface 18 plated on the metal plate-able polymer component 14 can function as the binding region 30 for the polymer resin 26 (FIG. 3B) although one or more visually exposed regions 34 should exist for a partially exposed chrome or metallized appearance. The binding region 30 includes the locking member 22 along the edge member 46. FIG. 3B shows a cross-sectional view of the grille 42B of FIG. 2B taken along the line IIIB-IIIB where the polymer resin 26 is coupled to the binding region 30 of the metallized surface 18 coupled to the metal plate-able polymer component 14 molded from a metal plate-able polymer 54.

In some embodiments, the plastic bonds can be relatively weak when the polymer resin 26 is over-molded to the metallized surface 18 base. In addition, the polymer resin 26 can frequently have a higher coefficient of linear expansion (CLTE) than the metallized surface 18 which can present adherence issues when the polymer resin 26 and the molded metallized polymeric structure 10 are exposed to varying temperatures in the hot sun or cold snow for example. To help the polymer resin 26 remain coupled to the metallized surface 18 of the metal plate-able polymer component 14, the polymer resin 26 can be injection molded onto the metallized surface 18 and be positioned to be in contact with the one or more locking members 22. In some embodiments, the locking members 22 have a flange and/or clip member that act to help position a layer of the polymer resin 26 onto the metallized surface 18 of the metal plate-able polymer component 14. These locking members 22 can help reduce the relative growth between the over-molded polymer resin 26 and the metallized surface 18 of the metal plate-able polymer component 14 by creating a mechanical attachment/locking feature to secure and couple the two materials.

Depending on the design of the molded metallized polymeric structure 10, the one or more locking members may have a variety of different shapes. For example, the linear grille 42A (shown in FIG. 2A) may have an extended edge locking member 22 that runs the length of a bar on the linear grille 42A. In another example, the checkered grille 42B (shown in FIG. 2B) may have a diamond or a rectangular shaped 22 locking member 22 to position the polymer resin 26 onto the metallized surface 18 of the metal plate-able polymer component 14. Depending on the visually exposed regions 34 and their corresponding designs, the one or more locking members 22 can have extended edge locking members, circular locking members, oval locking members, square locking members, rectangular locking members, diamond locking members, pyramid locking members, or any other geometric shape or combination thereof.

Referring to FIGS. 4A-4B, a two-shot rotational injection molding machine 50 may be used for making the molded metallized polymeric structure 10. Due to fabrication and assembly steps being performed inside one or more molds, molded multi-material objects allow significant reduction in assembly operations and production times. Furthermore, the product quality can be improved, and the possibility of manufacturing defects and total-manufacturing costs can be reduced. In multi-material injection molding, multiple different materials are injected into a multi-stage mold. The sections of the mold that are not be filled during the molding stage are temporarily blocked. After the first injected material sets, one or more blocked portions of the mold are opened and the next material is injected. This process continues until the required multi-material part is created.

According to some embodiments, a multi-shot molding process is used to form the metal plate-able polymer component 14 of the molded metallized polymeric structure 10. The metal plate-able polymer component 14 is formed through a first injection-molding step and is made from the metal plate-able polymer 54. In this step, the metal plate-able polymer 54 is sped through a first addition member 58 that introduces the metal plate-able polymer 54 to a first injection screw 62 that both melts and delivers the metal plate-able polymer 54 to a first open mold space 66 of a first mold 70.

The polymer resin 26 may be coupled to the one or more binding regions 30 of the metallized surface 18 where the polymer resin 26 is sped through a second addition member 74 that introduces the polymer resin 26 to a second injection screw 78 that both melts and delivers the polymer resin 26 to a second open mold space 82 of a second mold 86. Once the polymer resin 26 is coupled to the metallized surface 18 of the metal plate-able polymer component 14 the molded metallized polymeric structure 10 is formed. In some embodiments, upon completion of the dual injection steps, the first and second molds 70, 86 retract back and can rotate 180° so the metal plate-able polymer component 14 made in the first open mold space 66 is positioned in the second open mold space 82 so the polymer resin 26 may be coupled in the two step process. In other embodiments, upon completion of the dual injection steps, edges of the molded metallized polymeric structure 10 including the metal plate-able polymer component 14, the metallized surface 18, and polymer resin 26 may be over-molded with an additional multi-shot molding step using a second polymer resin or more of the polymer resin 26.

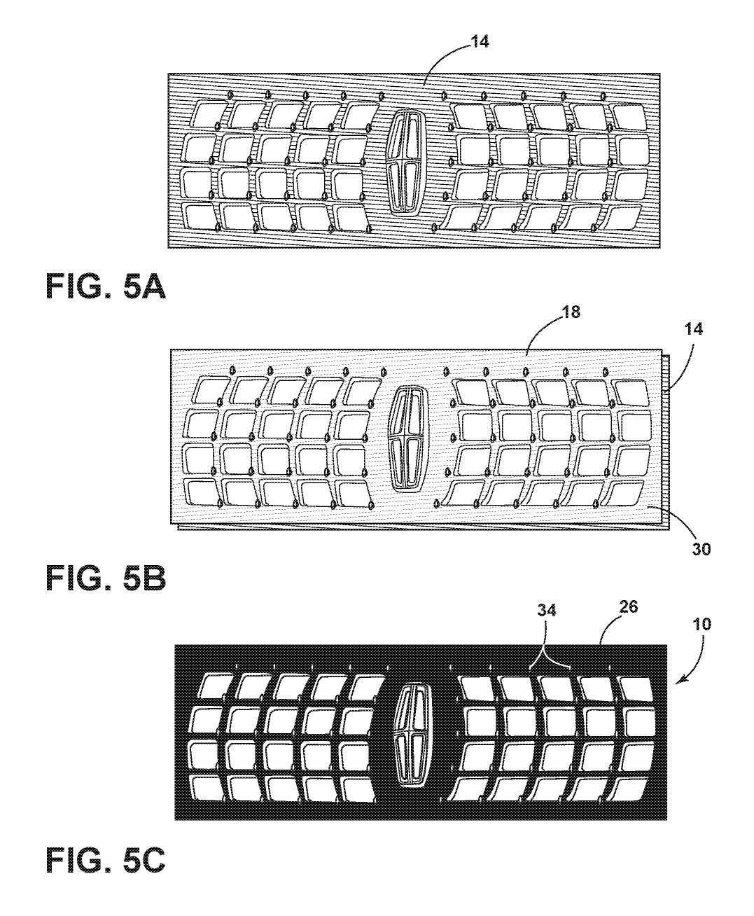

Referring to FIGS. 5A-5C, these figures represent the progression of the fabrication of the molded metallized polymeric structure 10 by visually showing the product at each of the respective steps described above with respect to FIGS. 4A-4B. FIG. 5A represents the metal plate-able polymer component 14 made in the first open mold space 66 of the two-shot rotational injection molding machine 50. FIG. 5B shows the metal plate-able polymer component 14 having the metallized surface 18 coupled to its surface providing the binding region 30 for the polymer resin 26 to be coupled to. FIG. 5C displays the molded metallized polymeric structure 10 having the polymer resin 26 coupled to the binding region 30 of the metallized surface 18 positioned on the metal plate-able polymer component 14.

Referring now to FIGS. 1-6, the method 200 of forming a molded metallized polymeric structure 10 includes injection molding a metal plate-able polymer component 14 having one or more locking members 22 (step 204). The method also includes metal plating the metal plate-able polymer component 14 to form a fully metallized surface 18 (step 208). The method further includes injection molding a polymer resin 26 to chemically bond to one or more regions of the fully metallized surface 18 kept in position by the one or more locking members 22 (step 212).

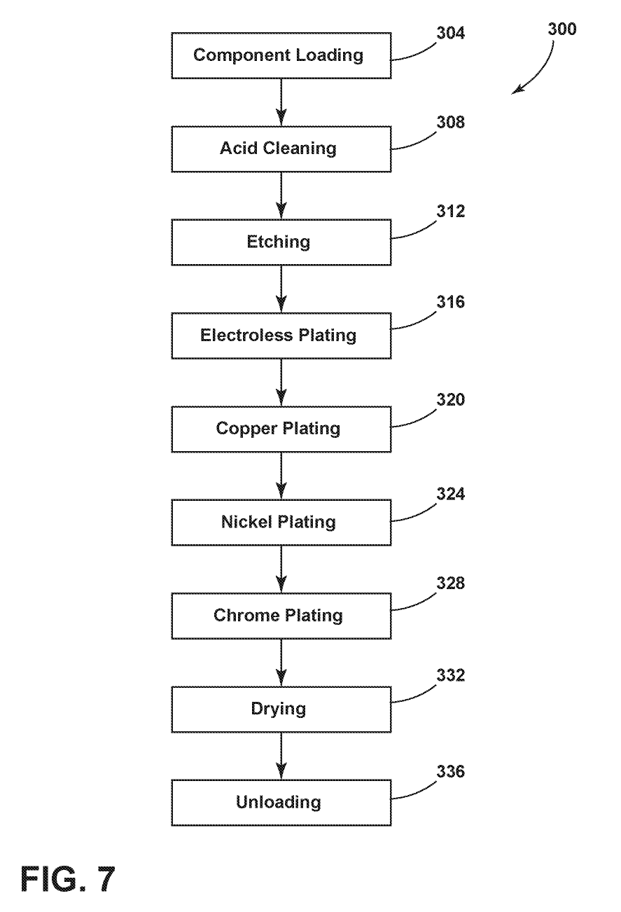

Referring now to FIG. 7, the method 300 for forming the metallized surface 18 on the metal plate-able polymer component 14 is shown. The method includes loading the metal plate-able polymer component 14 (step 304) and acid cleaning the component 14 (step 308). The acid cleaned component 14 is then etched (step 312) and the component 14 undergoes electroless plating (step 316). The method additionally includes copper plating (step 320) and/or nickel plating (step 324) where the copper and/or plated component 14 is then chrome plated (step 328). The metal plate-able polymer component 14 having the metallized surface 18 is then dried (step 332) and then unloaded to be later coupled to the polymer resin 26.

The cleaning step 308 includes cleaning the metal plate-able polymer component 14 in an acid bath while the etching step 312 includes etching the surface of the metal plate-able polymer component 14 using chromic acid and/or a sulfuric acid bath. An additional step of neutralizing the surface of the etched metal plate-able polymer component 14 using a water wash may be applied before the electroless plating in step 316. The electroless plating step 316 includes adding one or more layers of copper and/or nickel using a copper and/or nickel salt baths. With the metal plate-able polymer component 14 having an activating metallized surface 26 layer of copper and/or nickel, the metallized surface 26 of the metal plate-able polymer component 14 is chrome plated in step 328.

It is to be understood that variations and modifications can be made on the aforementioned structure without departing from the concepts of the present disclosure, and further it is to be understood that such concepts are intended to be covered by the following claims unless these claims by their language expressly state otherwise.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

### Listing of Non-Limiting Embodiments

Embodiment A is a molded metallized polymeric structure comprising a metal plate-able polymer component having a fully metallized surface with one or more locking members, a polymer resin coupled to one or more regions of the fully metallized surface wherein the polymer resin is positioned to be in contact with the one or more locking members, and one or more visually exposed portions of the fully metallized surface.

The structure of Embodiment A wherein the one or more locking members maintain the coupling of the polymer resin to the fully metallized surface.

The structure of Embodiment A or Embodiment A with any of the intervening features wherein the metal plate-able polymer component comprises acrylonitrile butadiene styrene copolymer or polycarbonate acrylonitrile butadiene styrene copolymer blends.

The structure of Embodiment A or Embodiment A with any of the intervening features wherein the polymer resin comprises an acrylonitrile styrene acrylate copolymer.

The structure of Embodiment A or Embodiment A with any of the intervening features wherein the one or more locking members comprises a flange.

The structure of Embodiment A or Embodiment A with any of the intervening features wherein the polymer resin comprises metal flakes, colorants, variable gloss finish, or a combination thereof.

The structure of Embodiment A or Embodiment A with any of the intervening features wherein the fully metallized surface is chrome, nickel, and/or any other metal alloy.

The structure of Embodiment A or Embodiment A with any of the intervening features wherein the molded metallized polymeric structure is a chrome grille.

Embodiment B is a method of forming a molded metallized polymeric structure, the method comprising injection molding a metal plate-able polymer component having one or more locking members, metal plating the metal plate-able polymer component to form a fully metallized surface, and injection molding a polymer resin to chemically bond to one or more regions of the fully metallized surface kept in position by the one or more locking members.

The method of Embodiment B wherein the one or more locking members maintain the coupling of the polymer resin to the fully metallized surface.

The method of Embodiment B or Embodiment B with any of the intervening features wherein the metal plate-able polymer component comprises acrylonitrile butadiene styrene copolymer or polycarbonate acrylonitrile butadiene styrene copolymer blends.

The method of Embodiment B or Embodiment B with any of the intervening features wherein the polymer resin comprises an acrylonitrile styrene acrylate copolymer.

The method of Embodiment B or Embodiment B with any of the intervening features wherein the polymer resin comprises metal flakes, colorants, variable gloss finish, or a combination thereof.

The method of Embodiment B or Embodiment B with any of the intervening features wherein the fully metallized surface is chrome, nickel, and/or any other metal alloy.

The method of Embodiment B or Embodiment B with any of the intervening features wherein the metal plating step further comprises cleaning the metal plate-able polymer component in an acid bath, etching a surface of the metal plate-able polymer component using a chromic acid and/or a sulfuric acid bath, neutralizing the surface of the metal plate-able polymer component using a water wash, adding one or more layers of copper and/or nickel using a copper and/or nickel salt bath, and chrome plating the surface of the metal plate-able polymer component.

The method of Embodiment B or Embodiment B with any of the intervening features wherein the injection molding steps are performed using a two-shot molding machine.

Embodiment C is a chromed lattice component for a vehicle comprising an acrylonitrile butadiene styrene copolymer component having a fully chromed surface wherein the component includes one or more locking members, a polymer resin coupled to one or more regions of the fully chromed surface wherein the polymer resin is positioned to be in contact with the one or more locking members, and one or more visually exposed portions of the fully chromed surface.

The component of Embodiment C wherein the polymer resin comprises an acrylonitrile styrene acrylate copolymer.

The component of Embodiment C or Embodiment C with any of the intervening features wherein the polymer resin comprises metal flakes, colorants, variable gloss finish, or a combination thereof.

The component of Embodiment C or Embodiment C with any of the intervening features wherein the one or more locking members maintain the coupling of the polymer resin to the fully chromed surface.

What is claimed is:

1. A molded metallized polymeric structure comprising:
a metal plate-able polymer component having a fully metallized surface with one or more locking members;
a polymer resin coupled to one or more regions of the fully metallized surface wherein the polymer resin is positioned to be in contact with the one or more locking members; and
one or more visually exposed portions of the fully metallized surface.

2. The molded metallized polymeric structure of claim 1, wherein the one or more locking members maintain the coupling of the polymer resin to the fully metallized surface.

3. The molded metallized polymeric structure of claim 1, wherein the metal plate-able polymer component comprises acrylonitrile butadiene styrene copolymer or polycarbonate acrylonitrile butadiene styrene copolymer blends.

4. The molded metallized polymeric structure of claim 1, wherein the polymer resin comprises an acrylonitrile styrene acrylate copolymer.

5. The molded metallized polymeric structure of claim 1, wherein the one or more locking members comprises a flange.

6. The molded metallized polymeric structure of claim 1, wherein the polymer resin comprises metal flakes, colorants, variable gloss finish, or a combination thereof.

7. The molded metallized polymeric structure of claim 1, wherein the fully metallized surface is chrome, nickel, and/or any other metal alloy.

8. The molded metallized polymeric structure of claim 1, wherein the molded metallized polymeric structure is a chrome grille.

9. A method of forming a molded metallized polymeric structure, the method comprising:
injection molding a metal plate-able polymer component having one or more locking members;
metal plating the metal plate-able polymer component to form a fully metallized surface; and
injection molding a polymer resin to chemically bond to one or more regions of the fully metallized surface kept in position by the one or more locking members.

10. The method of claim 9, wherein the one or more locking members maintain the coupling of the polymer resin to the fully metallized surface.

11. The method of claim 9, wherein the metal plate-able polymer component comprises acrylonitrile butadiene styrene copolymer or polycarbonate acrylonitrile butadiene styrene copolymer blends.

12. The method of claim 9, wherein the polymer resin comprises an acrylonitrile styrene acrylate copolymer.

13. The method of claim 9, wherein the polymer resin comprises metal flakes, colorants, variable gloss finish, or a combination thereof.

14. The method of claim 9, wherein the fully metallized surface is chrome, nickel, and/or any other metal alloy.

15. The method of claim 9, wherein the metal plating step further comprises:
cleaning the metal plate-able polymer component in an acid bath;
etching a surface of the metal plate-able polymer component using a chromic acid and/or a sulfuric acid bath;
neutralizing the surface of the metal plate-able polymer component using a water wash;
adding one or more layers of copper and/or nickel using a copper and/or nickel salt bath; and
chrome plating the surface of the metal plate-able polymer component.

16. The method of claim 9, wherein the injection molding steps are performed using a two-shot molding machine.

17. A chromed lattice component for a vehicle comprising:
an acrylonitrile butadiene styrene copolymer component having a fully chromed surface wherein the component includes one or more locking members;
a polymer resin coupled to one or more regions of the fully chromed surface wherein the polymer resin is positioned to be in contact with the one or more locking members; and
one or more visually exposed portions of the fully chromed surface.

18. The chromed lattice component for a vehicle of claim 17, wherein the polymer resin comprises an acrylonitrile styrene acrylate copolymer.

19. The chromed lattice component for a vehicle of claim 17, wherein the polymer resin comprises metal flakes, colorants, variable gloss finish, or a combination thereof.

20. The chromed lattice component for a vehicle of claim 17, wherein the one or more locking members maintain the coupling of the polymer resin to the fully chromed surface.
